(19) United States
(12) Patent Application Publication
(10) Pub. No.: US 2019/0276356 A1
(43) Pub. Date: Sep. 12, 2019

(54) STRENGTHENED GLASS-BASED ARTICLES AND METHODS FOR REDUCING WARP IN STRENGTHENED GLASS-BASED ARTICLES

(71) Applicant: CORNING INCORPORATED, CORNING, NY (US)

(72) Inventors: John Steele Abbott, Elmira, NY (US); Douglas Clippinger Allan, Corning, NY (US); John Martin Darfin, Christiansburg, VA (US); Sumalee Likitvanichkul Fagan, Painted Post, NY (US); David Lee Weidman, Corning, NY (US); David Inscho Wilcox, Mansfield, PA (US)

(21) Appl. No.: 16/463,692

(22) PCT Filed: Nov. 29, 2017
(86) PCT No.: PCT/US2017/063574

§ 371 Date: May 23, 2019

Related U.S. Application Data
(60) Provisional application No. 62/427,311, filed on Nov. 29, 2016.

(51) Int. Cl. C03C 21/00; C03C 15/00

(52) U.S. Cl. CPC C03C 21/002; C03C 15/00

(57) ABSTRACT

Strengthened glass substrates and methods of reducing warp in strengthened glass substrates having 3D and 2.5D shapes are disclosed. In one embodiment, a strengthened glass-based article includes a first surface, a second surface opposite the first surface, and an edge between the first surface and the second surface. The edge is asymmetric with respect to a plane that is located at an average depth of the strengthened glass-based article and is parallel to the first surface and the second surface. The strengthened glass-based article has an expected warp W_{E} based at least in part on a shape of the asymmetric edge of the strengthened glass-based article. An actual warp W_{A} of the strengthened glass-based article is less than 85% of the expected warp metric W_{E} of the strengthened glass-based article. The actual warp W_{A} of the strengthened glass-based article is measured with a concave surface facing up.

### CROSS-REFERENCE TO RELATED APPLICATIONS

This application claims priority to U.S. Pat. Appl. No. 62/427,311 filed on Nov. 29, 2016 and entitled “Chemically Strengthened Glass Articles and Methods for Reducing Warp in Chemically Strengthened Glass Articles,” which is incorporated by reference herein in its entirety.

### BACKGROUND

### Field

The present disclosure generally relates to strengthened glass-based articles and, more particularly, strengthened glass-based articles and methods for reducing warp in strengthened articles.

### Technical Background

Glass-based articles, such as cover glasses for electronic displays found in handheld devices, television displays, and computer monitors, may be chemically strengthened by an ion-exchange process to improve strength and scratch resistance. Further, it may be desirable for glass-based articles to have a three dimensional (3D) shape (e.g., non-planer shapes such as curves and other features) or a 2.5 dimensional (2.5D) shape in which edges are beveled or otherwise shaped. However, 3D and 2.5D glass-based articles that are chemically strengthened may exhibit warp due to the differential thicknesses of the glass-based article, which may cause unbalanced strain that causes warp. Extreme warp may be undesirable, and lead to product failure.

### SUMMARY

In one embodiment, a strengthened glass-based article includes a first surface having a first compressive stress layer extending from the first surface into a bulk of the strengthened glass-based article, a second surface having a second compressive stress layer extending from the second surface opposite the first surface and into a bulk of the strengthened glass-based article, and an edge between the first surface and the second surface. Each of the first compressive stress layer and the second compressive stress layer has a depth of compression of the smaller of greater than or equal to 40 μm or greater than or equal to 10% of a thickness of the strengthened glass-based article. The edge provides a non-orthogonal transition between the first surface and the second surface such that the edge is asymmetric with respect to a plane that is located at an average depth of the strengthened glass-based article and is parallel to the first surface and the second surface. The strengthened glass-based article has an expected warp W_{E} based at least in part on a shape of the asymmetric edge of the strengthened glass-based article. An actual warp W_{A} of the strengthened glass-based article is less than 85% of the expected warp metric W_{E} of the strengthened glass-based article. The actual warp W_{A} of the strengthened glass-based article is measured with a concave surface facing up.

In another embodiment, a method of fabricating a strengthened glass-based article includes positioning a glass-based article into an ion-exchange bath for a duration of time. The glass-based article has a first surface, a second surface opposite the first surface, and an edge between the first surface and the second surface. The edge provides a non-orthogonal transition between the first surface and the second surface such that the edge is asymmetric with respect to a plane that is located at an average depth of the strengthened glass-based article and is parallel to the first surface and the second surface. The ion-exchange bath forms the strengthened glass-based article. The strengthened glass-based article includes a first compressive stress layer extending from the first surface into a bulk of the strengthened glass-based article and having a first depth of compression, and a second compressive stress layer extending from the second surface into the bulk of the strengthened glass-based article and having a second depth of compression. The method further includes, after positioning the glass-based article to the ion-exchange bath, removing a portion of at least the second compressive stress layer such that a warp of the strengthened glass-based article after removing the portion of at least the second compressive stress layer is less than a warp of the strengthened glass-based article before removing the portion of at least the second compressive stress layer.

In yet another embodiment, a method of fabricating a strengthened glass-based article includes applying a surface treatment to at least a portion of a first surface of a glass-based article, the glass-based article having the first surface, a second surface opposite the first surface, and an edge between the first surface and the second surface. The edge provides a non-orthogonal transition between the first surface and the second surface, and the edge is asymmetric with respect to a plane that is located at an average depth of the strengthened glass-based article and is parallel to the first surface and the second surface. The method further includes positioning the glass-based article into an ion-exchange bath for a duration of time. The ion-exchange bath strengthens the glass-based article to form the strengthened glass-based article. The strengthened glass-based article includes a first compressive stress layer extending from the first surface into a bulk of the strengthened glass-based article thereby defining a first depth of compression, and a second compressive stress layer extending from the second surface opposite the first surface and into a bulk of the strengthened glass-based article thereby defining a second depth of layer. The surface treatment results in an ion diffusivity in the first compressive stress layer that is different from an ion diffusivity in the second compressive stress layer.

In yet another embodiment, a method of fabricating a strengthened glass-based article includes positioning a glass-based article into an ion-exchange bath for a duration of time. The glass-based article has a first surface, a second surface opposite the first surface, and an edge between the first surface and the second surface. The edge provides a non-orthogonal transition between the first surface and the second surface and the edge is asymmetric with respect to a plane that is through an average depth of the strengthened glass-based article and is parallel to the first surface and the second surface. The glass-based article is tilted within the ion-exchange bath such that one of the first surface and the second surface faces away from a bottom of the ion-exchange bath. The method further includes removing the strengthened glass-based article from the ion-exchange bath after the duration of time. The strengthened glass-based article has a first compressive stress layer extending from the first surface into a bulk of the strengthened glass-based article to a first depth of layer, and a second compressive stress layer extending from the second surface opposite the first surface and into a bulk of the strengthened glass-based article to a second depth of layer. The strengthened glass-based article has an expected warp W_{E} based at least in part on a shape of the asymmetric edge of the strengthened glass-based article, and an actual warp W_{A} of the strengthened glass-based article is less than 85% of the expected warp metric W_{E} of the strengthened glass-based article. The actual warp W_{A} of the strengthened glass-based article is measured with a concave surface facing up.

In yet another embodiment, a method of fabricating a strengthened glass-based substrate includes pre-warping a glass-based article such that the glass-based article has a pre-warp W_{P} in a first direction. The glass-based article has a first surface, a second surface, and an edge between the first surface and the second surface. The edge provides a non-orthogonal transition between the first surface and the second surface such that the edge is asymmetric with respect to a plane that is located at an average depth of the strengthened glass-based article and is parallel to the first surface and the second surface. The method further includes positioning a glass-based article into an ion-exchange bath for a duration of time. The ion-exchange bath forms the strengthened glass-based article such that a first compressive stress layer extends from the first surface into a bulk of the strengthened glass-based article to a first depth of layer, and a second compressive stress layer extends from the second surface into the bulk of the strengthened glass-based article to a second depth of layer. The strengthened glass-based article has an expected warp W_{E} based at least in part on a shape of the asymmetric edge of the strengthened glass-based article. The strengthened glass-based article warps in a second direction opposite the first direction of the pre-warp W_{P} such that an actual warp W_{A} of the strengthened glass-based article is less than 85% of the expected warp W_{E} of the strengthened glass-based article. The actual warp W_{A} of the strengthened glass-based article is measured with a concave surface facing up.

Additional features and advantages of the embodiments of the present disclosure will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 schematically depicts a glass-based article according to one or more embodiments described and illustrated herein;

FIG. 2 schematically depicts a beveled edge of a glass-based article according to one or more embodiments described and illustrated herein;

FIG. 3 schematically depicts a curved edge of a glass-based article according to one or more embodiments described and illustrated herein;

FIG. 4 schematically depicts an ion-exchange process according to one or more embodiments described and illustrated herein;

FIG. 5A schematically depicts a perspective view of a strengthened glass-based article having a warp according to one or more embodiments described and illustrated herein;

FIG. 5B schematically depicts a side view of a strengthened glass-based article having a warp disposed on a flat surface according to one or more embodiments described and illustrated herein;

FIG. 6A schematically depicts a beveled edge of a strengthened glass-based article according to one or more embodiments described and illustrated herein;

FIG. 6B schematically depicts a cross section of a glass-based article having an asymmetric edge according to one or more embodiments described and illustrated herein;

FIG. 7 graphically illustrates a warp evolution of a strengthened glass-based article through a plurality of process steps;

FIG. 8 graphically illustrates a warp evolution of a strengthened glass-based article through a plurality of process steps including polishing a surface of the strengthened glass-based article according to one or more embodiments described and illustrated herein;

FIG. 9A graphically depicts a plot of the warp of a glass sheet following ion-exchange and prior to any material removal according to one or more embodiments described and illustrated herein;

FIG. 9B graphically depicts a plot of the warp of the glass sheet depicted in FIG. 9A following etching of a surface according to one or more embodiments described and illustrated herein;

FIG. 10 graphically depicts a plot that illustrates the amount of warp as a function of material removal by etching from an upper side or a lower side after ion-exchanging a glass-based article according to one or more embodiments described and illustrated herein;

FIG. 11 graphically depicts a chart illustrating pre-ion-exchange and post-ion-exchange warp for glass-based articles having no surfaces polished prior to ion-exchange and one surface polished prior to ion-exchange according to one or more embodiments described and illustrated herein;

FIG. 12A graphically illustrates a plot of the warp of a glass sheet prior to ion-exchange and after the B-side of the glass sheet was etched according to one or more embodiments described and illustrated herein;

FIG. 12B graphically illustrates a plot of the warp of the glass sheet depicted in FIG. 12A after ion-exchange according to one or more embodiments described and illustrated herein;

FIG. 13 graphically illustrates warp of strengthened glass sheets as a function of material removed by etching prior to ion-exchange according to one or more embodiments described and illustrated herein;

FIG. 14A schematically depicts glass-based articles positioned in an ion-exchange bath in a tilted arrangement according to one or more embodiments described and illustrated herein;

FIG. 14B schematically depicts the warp of the glass-based articles positioned in the ion-exchange bath depicted in FIG. 14A according to one or more embodiments described and illustrated herein;

FIG. 15A graphically illustrates a plot of the warp of a glass sheet prior to ion-exchange according to one or more embodiments described and illustrated herein;

FIG. 15B graphically illustrates a plot of the warp of the glass sheet of FIG. 15A due to tilt loading within an ion-exchange bath according to one or more embodiments described and illustrated herein;

FIG. 16A graphically illustrates a plot of the warp of a glass sheet prior to ion-exchange according to one or more embodiments described and illustrated herein; and

FIG. 16B graphically illustrates a plot of the warp of the glass sheet of FIG. 16A due to tilt loading within an ion-exchange bath according to one or more embodiments described and illustrated herein.

### DETAILED DESCRIPTION

Referring generally to the figures, embodiments of the present disclosure are generally related methods for reducing warp in ion-exchanged strengthened glass-based articles, such as strengthened glass-based articles used as cover glass in electronic devices such as smart phones and television displays.

As used herein, the term “glass-based article” includes glass and glass-ceramic materials.

Electronic devices may utilize a cover glass that is not two dimensional but rather three dimensional or 2.5 dimensional. As used herein three dimensional (3D) glass-based articles have at least a portion that is non-planar and possess features such as curved surfaces. As used herein, 2.5 dimensional glass-based articles are generally planar but have an edge that is non-orthogonal to first and second surfaces of the glass-based articles (e.g., a curved edge, a beveled edge, a chamfered edge, and the like). As used herein, glass-based articles are glass-based articles fabricated from a nominally symmetric fabrication process. As used herein, the phrase “nominally symmetric” means that the environment on both sides of the glass-based material is substantially the same during formation of the glass article. Examples of nominally symmetric fabrication processes include, but are not limited to, a fusion draw process and a rolling process. A float process is an example of a fabrication process that is not nominally symmetric because one side of the glass material is exposed to the atmosphere, while the other side of the glass material is exposed to molten metal, such as tin. Thus, the environment is asymmetric in a float glass fabrication process.

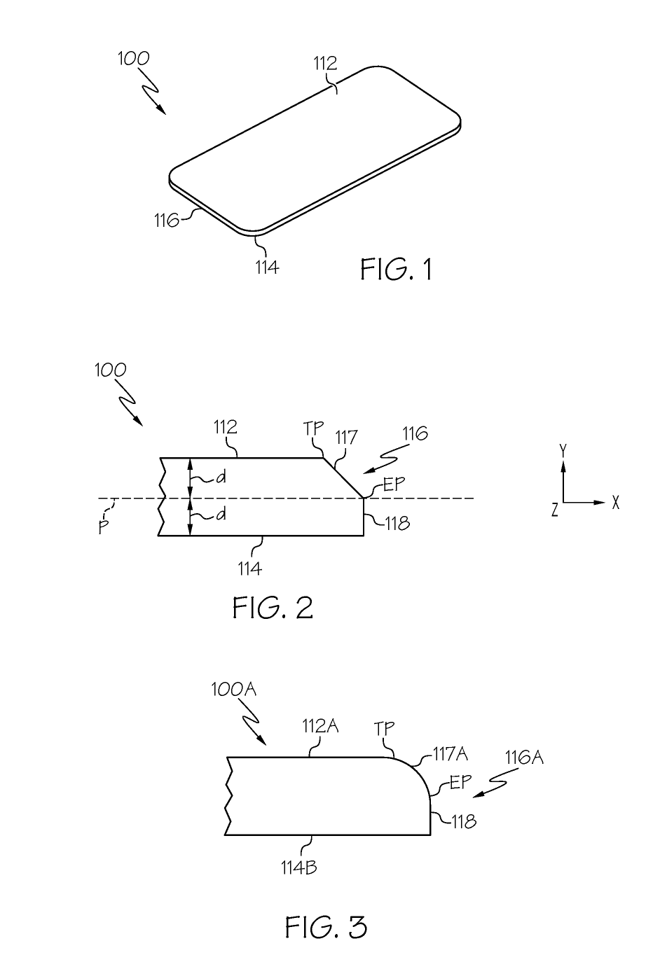

FIG. 1 schematically illustrates an example glass-based article 100 that may be utilized for a handheld device, such as a smart phone. The glass-based article 100 has a first surface 112, a second surface 114, and an edge 116 disposed between the first surface 112 and the second surface 114. The first surface 112 and the second surface 115 are planar and parallel to one another. FIG. 2 schematically depicts the glass-based article 100 of FIG. 1 having a beveled edge 116, wherein a transition portion 117 of the beveled edge 116 is non-orthogonal to the first surface 112 and the second surface 114. Thus, the glass-based article 100 depicted by FIG. 2 is 2.5D. The transition portion 117 non-orthogonally extends from a transition point TP on the first surface to an end point EP located at the furthest most point of the glass-based article along the positive or negative x-axis. An edge surface 118 that is orthogonal to the first surface 112 and the second surface 114 connects the transition portion 117 to the second surface 114. It is noted that the transition portion 117 may extend all the way to the second surface 114 such that the end point EP of the transition portion 117 is at the second surface. In such embodiments, there may be little or no edge surface 118 that is orthogonal to the first surface 112 and the second surface 114. In other embodiments, a second transition portion (not shown) may transition from the edge surface 118 to the second surface 114.

FIG. 3 schematically depicts another example 2.5D glass-based article 100A having a curved edge 116A comprising a transition portion 117A that is curved and is non-orthogonal to the first surface 112A and the second surface 114A. The curved transition portion 117A starts at a transition point TP where the curved edge 116 begins to curve, and ends at an end point EP where the curved transition portion 117A reaches the edge surface 118 that is orthogonal to the first surface 112A and the second surface 114B.

It should be understood that other edge-shapes are possible. The edge shape of 2.5 glass-based articles may take on any shape that provides a non-orthogonal transition between the first surface and the second surface, and is asymmetric with respect to a plane that is both located at an average depth of the strengthened glass-based article and is parallel to the first surface 112 and the second surface 114. Referring once again to FIG. 2, a center-of-mass plane P is located at an average depth d within a bulk of the glass-based article 100. The plane P is also parallel to the first surface 112 and the second surface 114. As shown in FIG. 2, the edge 116 is asymmetric with respect to the center-of-mass plane P because the upper portion of the edge 116 includes a non-orthogonal transition portion 117 while the bottom portion of the edge 116 does not include a non-orthogonal transition portion 117.

It is noted that, in 2.5D glass-based articles, the first surface 112 is generally the consumer facing surface. Due to the shape of the edge of a 2.5D glass-based article, a surface area of the first surface may be smaller than a surface area of the second surface because of the transition portion.

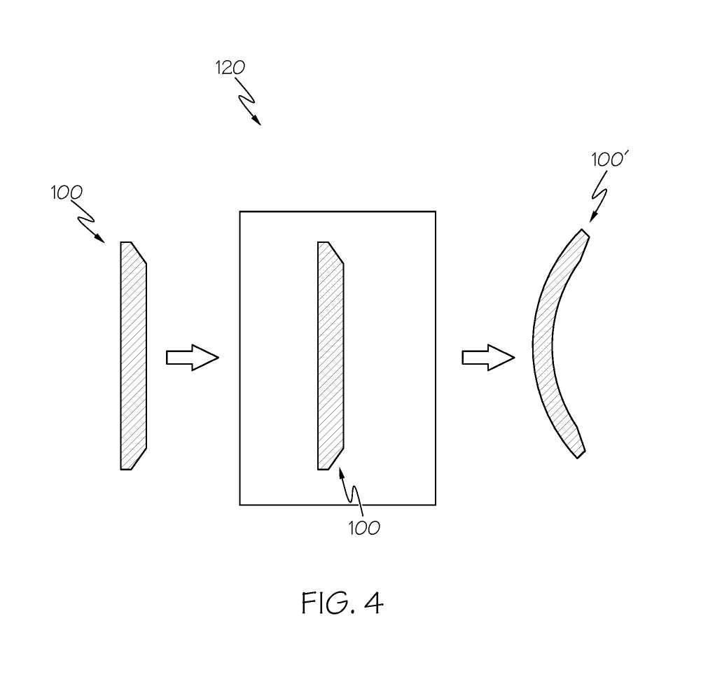

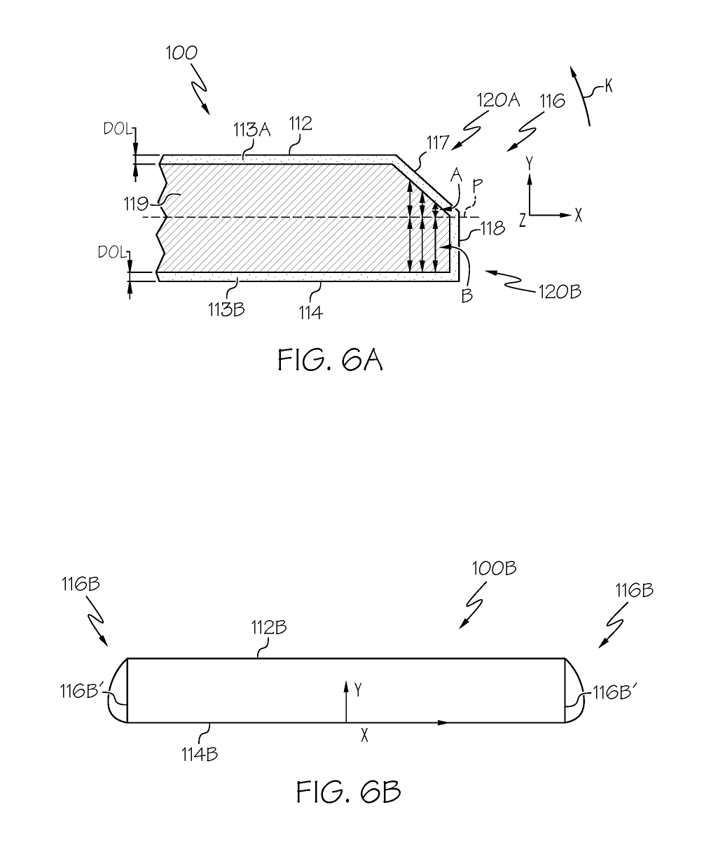

Glass-based articles, such as those used in handheld devices and television displays, may be strengthened by an ion-exchange process to increase strength and scratch resistance. Referring to FIG. 4, a non-strengthened glass-based article 100 may be disposed in an ion-exchange bath 120 for a period of time in accordance with an ion-exchange process. Larger ions within the ion-exchange bath 120 are exchanged with smaller ions of the glass material. As an example and not a limitation, the ion-exchange bath 120 may comprise a potassium salt bath such that larger potassium ions are exchanged with sodium ions of the glass material. Referring briefly to FIG. 6A, the exchange of ions occurs from a surface of a glass-based article to a depth of layer (DOL). The exchange of ions result in a depth of compression (DOC) where the stress changes from compressive stress to tensile stress. The ion-exchanged region is referred to as a compressive stress layer. Thus, a first compressive stress layer 113A is present at the first surface 112 and a second compressive stress layer 113B is present at the second surface. The first and second compressive stress layers 113A, 113B possess compressive stress, which is balanced by tensile stress within a central tension region 119 between the first compressive stress layer 113A and the second compressive stress layer 113B.

As used herein, the terms “depth of layer” and “DOL” refer to the ion penetration depth as determined by surface stress meter (FSM) measurements using commercially available instruments such as the FSM-6000 sold by Orihara Industrial Co., Ltd. of Tokyo, Japan.

As used herein, the terms “depth of compression” and “DOC” refer to the depth at which the stress within the glass changes from compressive to tensile stress. At the DOC, the stress crosses from a negative (compressive) stress to a positive (tensile) stress and thus has a value of zero. The DOC values described herein are measured using a scattered light polariscope (SCALP), such as, without limitation, a SCALP sold by Glasstress Ltd., of Tallinn, Estonia under the model number SCALP-04.

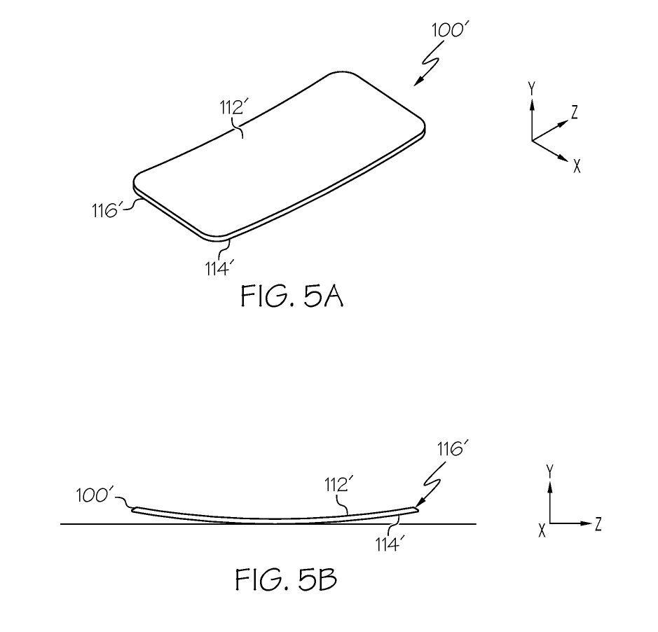

As schematically shown in FIG. 4, strengthened glass-based articles 100′ having a 3D or 2.5D shape may exhibit warp, meaning that the resulting strengthened glass-based article is no longer flat following the ion-exchange process. Particularly, for an exemplary 2.5D beveled glass-based article that starts out having no warp prior to the ion-exchange process, the glass-based article will be warped during the ion-exchange process with a shape predominantly concave towards the beveled side of the glass-based article (e.g., the first surface 112 depicted in FIGS. 1-3). FIG. 5A schematically depicts a perspective view of a strengthened glass-based article 100′ having a warped shape. FIG. 5B schematically depicts a strengthened glass-based article 100′ having a warped shape disposed on a flat surface.

It has been shown that ion-exchange induced warp may cause strengthened glass-based articles to exhibit warp beyond desired thresholds where the DOC is greater than or equal to 40 μm. In particularly thin glass-based articles (e.g., a thin glass-based article having a thickness of less than or equal to 0.4 mm), which are also prone to warping due to asymmetric edges, warping may occur when the DOC is greater than or equal to 10% of a thickness of the strengthened glass-based article. Thus, warping may cause a glass-based article to be out of specification when the glass-based article has a DOC of at least the smaller of greater than or equal to 40 μm or greater than or equal to 10% of a thickness of the strengthened glass-based article.

Without being bound by theory, the warp may be the result of imbalanced force moments from the compressive stress layers in the region of the bevel. Ion-exchange strengthening is fundamentally driven by the strain (expansion) of the near-surface region where larger the ions replace the smaller ions. This same strain may drive warp when the strain is applied asymmetrically such as asymmetric geometry of a beveled glass-based article.

Briefly, the mechanism causing this warp may be explained by considering the geometry near the beveled edge. Referring to FIG. 6A, a cross-section through a beveled edge 116 of a strengthened glass-based article 100 through the x-y plane is schematically illustrated. The strengthened glass-based article 100 can be thought of as projecting into and out of the page, in the third dimension z.

In the case of a beveled edge 116 (or other non-orthogonal, asymmetric edge defining a 2.5D glass-based article) as shown in FIG. 6A, a non-beveled area 120B of the edge 116 proximate the second surface 114 has near-surface glass that is further from the center-of-mass plane P through the average thickness of the glass-based article than that of the beveled area 120A of the edge 116 having the transition portion 117 proximate the first surface 112. Referring to arrows A in FIG. 6A, the glass material is progressively thinner than corresponding area represented by arrows B due to the transition portion 117 of the beveled edge 116.

As noted above, in an ion-exchange process, larger ions diffuse into the glass, exchanging with smaller ions. As a result, the glass network must expand. Referring to FIG. 6A, and comparing the elastic energy reduction when the beveled area 120A versus the non-beveled area 120B as they expand, the distance from the center-of-mass plane P is greater for the non-beveled area 120B, so it has more leverage or gains more increased area through bending the part in a way to “curl” the ends along ±z into a shape that is concave on the first surface 112 or convex on second surface 114. Thus, the strain within the second compressive stress layer 113B proximate the beveled edge 116 provides a larger “bending moment” than the strain of the opposing first compressive stress layer 113A, which drives warp convex toward the non-beveled side in a directed indicated by arrow K. It has been observed that deeper DOL (e.g., up to 100 μm) results in greater warp.

More complex edge shapes beyond a simple bevel as shown in FIG. 6A may further increase warp. Similarly, for large size pieces (in particular, sizes for computer displays and TVs) it is very easy for a small shape variation to result in out-of-plane shapes that move a surface below the nominal mid-plane (or center-of-mass plane) and achieve the imbalance of forces described above.

This warp is not common in 2D (flat) glass-based articles following an ion-exchange process as long as the ion exchange properties such as diffusivity are symmetric, but is instead the result of the interaction between the 2.5D or 3D shape of the glass-based article and the forces on the part resulting from ion-exchange. However, warp may occur in larger glass-based articles (e.g., glass-based articles utilized for larger electronic displays such as computer monitor and television displays) and thin glass-based articles (e.g., glass-based articles having a thickness of less than or equal to 400 μm) due to unbalanced strain caused by asymmetric physical properties through a thickness dimension of the glass-based material. Any physical property of the glass-based material that causes unbalanced strain between a first surface and a second surface of the glass-based material may cause warp. Two physical properties other than 2.5D and 3D shapes that may affect warp include, but are not limited to, asymmetry of the diffusivity of ions during the ion exchange process between the first surface and the second surface (i.e., how far and how many ions enter each surface during ion exchange), and asymmetry of the surface chemistry of the glass-based material which affects both how many ions enter and the magnitude of exchanged ion concentration at each surface. Metrics for how two characterize these two sources of warp are described in U.S. patent application Ser. No. 14/170,023 and is hereby incorporated by reference in its entirety. It should be understood that factors other than 2.5D or 3D shape of the glass-based article may be accounted for in reducing warp.

Excessive warp resulting from a 2.5D or 3D shape may not meet end product specifications. As a non-limiting example, evaluation of warp on phone-size parts indicates an average warp increase during ion-exchange of 50 μm to more than 100 μm for some edge designs, which may be undesirable.

FIGS. 5A and 5B specifically describe the warp after strengthening that arises for a theoretically flat piece which has a bevel around the top edge, but are a heuristic for warp in general. Actual pieces may be measured for warp before and after ion-exchange processes and/or before and after warp mitigation processes described herein. In general, the warp is determined as follows: (1) measure the shape of the second surface 114, the first surface 112, or the center-of-mass P of the piece using for example measuring instruments described below; (2) use multiple linear regression to find a least squares best-fit “average plane” that defines a perfectly flat mathematical plane that on average goes through the measured data points and defines the orientation of the part in space; (3) subtract the best-fit plane from the data set of points that characterize the shape measured in (1); and (4) use the subtracted data points to calculate the maximum (positive) and minimum (negative) deviation of any measured data point from the average plane along the dimension perpendicular to the average plane. The final warp w, also called the total indicated runout or TIR, is the sum of the magnitudes of these two deviations. This procedure identifies the difference between the highest and lowest points on the part, projected onto the direction perpendicular to the part, after the part is oriented horizontally.

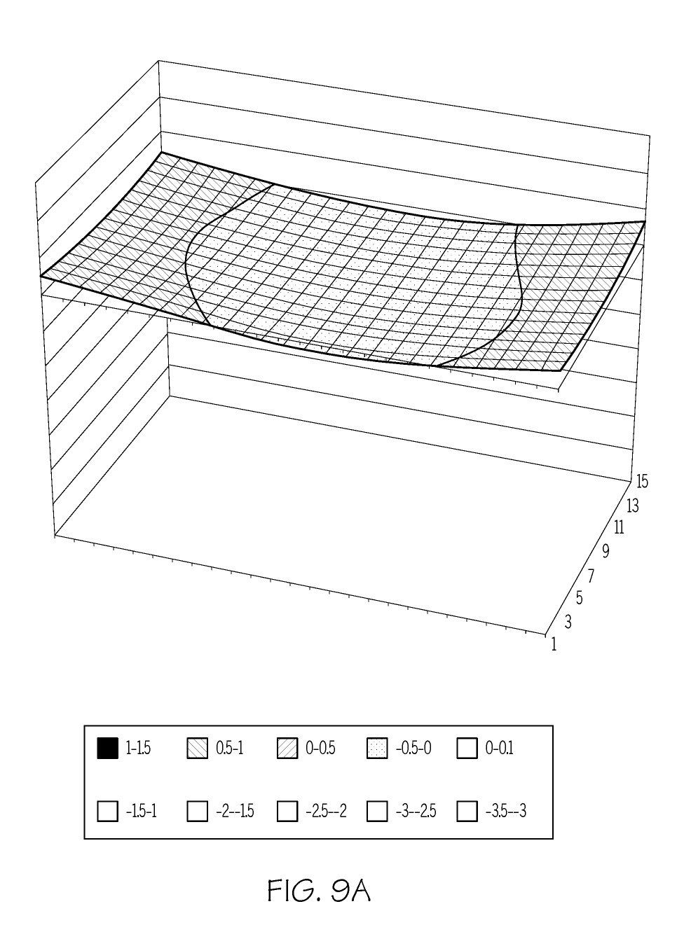

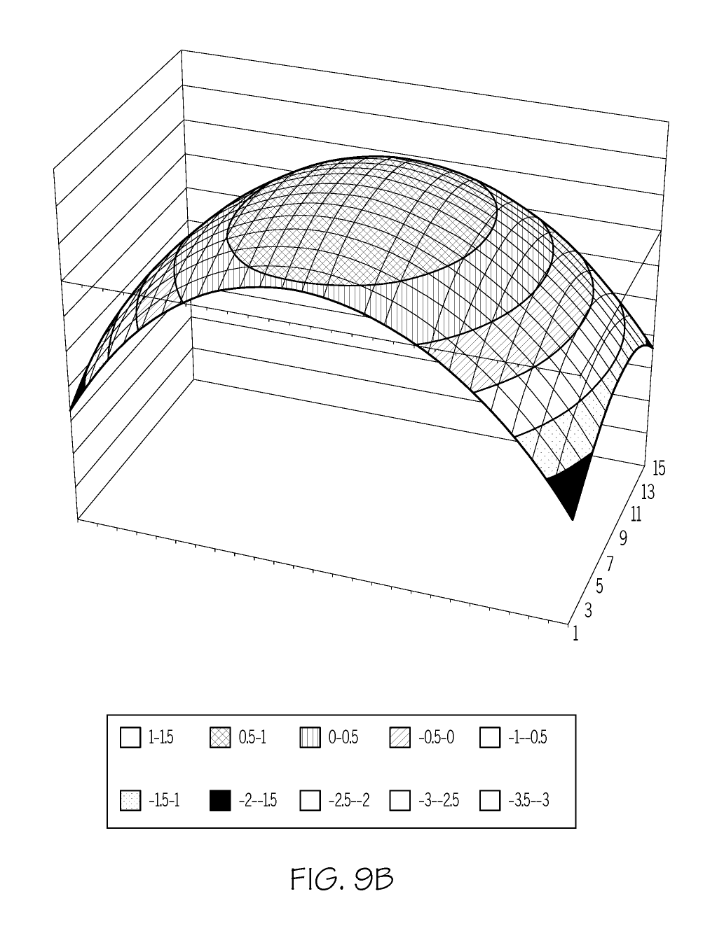

For small pieces and small warp values less than about 150 μm, the Flatmaster 200 interferometer sold by Tropel Metrology Instruments of Fairport, N.Y. is suitable to measure the warp. For larger pieces and larger warps (for example for television displays or computer monitors), the size and TIR is too large for the Flatmaster 200. In such cases, warp measurements may be made using the so-called “Bed of Nails” technique described in U.S. Pat. Nos. 7,509,218 and 9,031,813, which are hereby incorporated by reference in their entireties. It is noted that the warp w values disclosed herein were measured using a Flatmaster 200 unless otherwise stated. FIGS. 9A-B, 12A-B, 15A-B, 16A-B illustrate larger pieces that were measured using the Bed of Nails technique.

It is noted that, despite technically advanced measurements like “Bed of Nails” or a Flatmaster 200, some specifications measure warp by a “Feeler Gage.” The Feeler Gage method, although labor intensive, is essentially asset free. The Feeler Gage measurement is as follows: an article is placed on a flat surface, and the measurer attempts to slide a shim of known thickness in the gap between the article and the flat surface. The measurer iterates with differing shim thicknesses until a warp value at that location is determined. The measurer will repeat the process at locations around the article perimeter. Rules may be established for the measurement, such as the requirements for the flat surface, the distance the shim is to be inserted, the number of locations measured around the article perimeter, whether both sides of the article is to be measured, and the like.

An estimated amount of warp due to edge geometry may be calculated. As described hereinabove, an asymmetric geometry at the edge of an otherwise flat glass-based article gives rise to a bending moment that warps the part during ion exchange. Such an edge shape may be called beveled, chamfered, curved, splined, shaped, or the like. Because it is the asymmetry of the edge shape that drives warp, a quantitative metric may be used to distinguish “low asymmetry” from “high asymmetry” in the form of equations that can be applied to any edge shape.

An example glass-based article 100B having an asymmetric edge 116B between a first surface 112B and a second surface 114B is illustrated in FIG. 6B. This is not a limiting example; the expected warp W_{E} metric described herein applies to an arbitrary edge shape according to the rules given below. A cross-sectional shape is taken perpendicular to the longest axis of a rectangular, approximately flat glass-based article 100B. Lines 116B′ represent an edge that is not asymmetric in shape. It is noted that, although the present example is directed to a rectangular glass-based article, embodiments are not limited thereto. For example, the warp may be estimated and mitigated for, square, circular, elliptical and arbitrarily shaped glass-based articles.

For the purposes of the expected warp W_{E} metric, the glass-based article 100B is assumed to be mirror symmetric left to right as shown in FIG. 6B. If the edges are not symmetric as viewed in cross-section, then an average of the left shape and a mirror image of the right shape are formed, and both edge shapes are replaced by the average so as to impose left/right mirror symmetry.

Coordinates x, y, and z are established, where x goes left to right along the second longest length of the approximately parallelepiped shaped glass-based article 100B, y goes in the thickness direction, and z goes along the longest dimension into the plane of the drawing as shown in FIG. 6B. The origin of coordinates is located at the bottom of the centerline of the cross-section as shown in FIG. 6B.

Next, a strain scale is defined by measuring the ion exchange-induced length change per unit length along the longest dimension of the part. If we call the starting dimension L_{z} for length along the z direction and call the ion exchange-induced change in length δL_{z} then the strain scale is δL^{z}/L_{z}. This value will be different for different glasses and different ion exchange processes. Typical values are in the range of 200×10⁻⁶ to 2000×10⁻⁶.

The area A of the cross-section is given by:

A=∫∫dydx (1)

where the limits of integration for x go from the left edge to the right edge at every height y from the bottom to the top. This integral may be done numerically given a mathematical representation of the cross-sectional area of the part or by means of image analysis software. The center-of-mass lies on the centerline somewhere on the x=0 line by symmetry. The center-of-mass lies at the y value given by:

$$\overline{y} = \frac{1}{A} \int \int ydydx \qquad ( 2 )$$

It is noted that integral of Equation (2) may also be done numerically or by means of image analysis software. The value of Equation (2) is also the first y moment per unit area. The second y moment per unit area is given by

$$\overline{{y}^{2}} = \frac{1}{A} \int \int {y}^{2} dydx \qquad ( 3 )$$

The curvature, here denoted as K, is given by

$$K = \frac{{\partial }^{2} {u}_{y}}{\partial {z}^{2}} = - ( \frac{δ {L}_{z}}{{L}_{z}} ) \frac{{L}_{y}}{2} \frac{ ( y - \overline{y} ) dl}{A ( \overline{{y}^{2}} + {\overline{y}}^{2} )} \qquad ( 4 )$$

Here, u_{y} is an ion-exchange-induced deflection in the thickness (y) direction as a function of the length (z) direction;

$$\frac{δ {L}_{z}}{{L}_{z}}$$

is the strain scale defined above; L_{y} is the thickness; the numerator of the fraction is a line integral of (y−y̅) along the line that defines the outside edge of the cross section; A is the cross-sectional area defined above; and the other terms in the denominator were defined above.

The expected warp W_{E} metric is given by:

$${W}_{E} = \frac{1}{2} {( \frac{{L}_{z}}{2} )}^{2} K \qquad ( 5 )$$

When the expected warp W_{E} metric is positive, the warp shape is concave up (i.e., positive y direction) or the ends are higher than the center. When expect warp W_{E} metric is negative, the warp is of the opposite sense (i.e., negative y direction).

As stated above, warp may cause the glass-based article to become out of specification. Thus, glass-articles outside of a warp specification must be discarded, providing for lower yield. When designing glass-based articles with known edge geometry and strengthening characteristics, the expected warp W_{E} metric may be calculated to estimate how much the part will warp due to asymmetric edge shape. When a ratio of the magnitude of W_{E} calculated by Equation (5) to a longest length of the strengthened glass-based article is 0.0006, then the edge geometry together with the ion exchange process creates excessive warp in the part and one or more of the warp mitigation processes described hereinbelow may be applied to reduce the magnitude of warp.

Note that the strain scale

$$\frac{δ {L}_{z}}{{L}_{z}}$$

is a linear scale for the expected warp W_{E} metric. This linear strain scale is most easily measured by measuring the length of the part L, before ion exchange and then measuring the length again after all ion exchange steps are completed. The strain scale is given by:

$$\frac{δ {L}_{z}}{{L}_{z}} = \frac{{L}_{z} ( after ) - {L}_{z} ( before )}{{L}_{z} ( before )} \qquad ( 6 )$$

In typical production ion exchange processing, this change in length is tracked and accounted for to achieve final part dimensions. If the ion exchange process exchanges more ions then the strain scale will increase; if the strain scale doubles then the expected warp W_{E} also doubles.

It is noted that the expected warp W_{E} does not account for the effects of gravity, which will influence the actual measurement of warp of the glass-based articles. The effect of gravity on warp measurement will differ based on whether the glass-based article is measured with the convex surface facing down or the concave surface facing down. It has been shown that gravity reduces an actual warp measurement by approximately 7% when the concave surface is faced up (i.e., a bowl shape) during measurement, and by approximately 13% when the concave surface is faced down (e.g., a dome shape) during measurement. Thus, when comparing the measured warp to the expected warp W_{E} the effects of gravity should be considered.

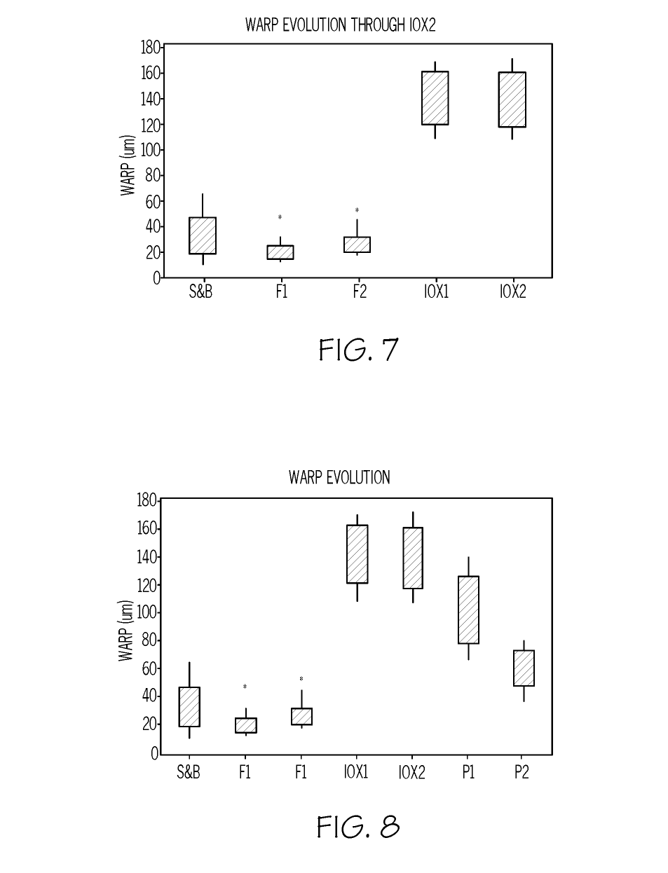

FIG. 7 graphically illustrates the effect of various glass-based article processing steps on warp in testing phone-sized glass-based articles. The warp measurements illustrated by FIG. 7 were obtained using the Flatmaster 200. The glass-based articles were fabricated from an alkali aluminosilicate composition. It should be understood that, although embodiments herein are described in the context of alkali aluminosilicate glass, such as Gorilla® Glass sold by Corning, Incorporated of Corning, N.Y., embodiments are not limited thereto. The concepts described herein are applicable to any ion-exchangeable glass compositions.

In FIG. 7, “S&B” stands for “score and break,” wherein multiple glass-based articles are separated from a mother glass sheet by a mechanical scribe and break process. The first “finishing” step F1 is a thinning step, where glass-based articles were thinned from 1.1 mm to 0.8 mm. The second “finishing” step F2 is the process of forming the beveled edge 116 as shown in FIG. 6A. “IOX1” represents a first ion-exchange process during which ions are deeply exchanged into the DOL within the glass-based article. During the first ion-exchange process IOX1, a DOL of 150 μm and a compressive stress (CS) of 226 MPa was achieved. “IOX2” represents a second ion-exchange process that creates a large concentration of larger ions as the surface of the glass-based article. Following the second ion-exchange process IOX2, a DOL of about 100 μm and a CS of about 835 MPa was achieved.

As shown in FIG. 7, the first ion-exchange process IOX1 significantly increases the amount of warp seen in the sample glass-based articles (e.g., more than 100 μm of warp). The second ion-exchange process IOX2 does not significantly contribute to the amount of warp. Thus, the large increase of warp after the first ion-exchange process IOX1 appears to be result of the interaction between the shape of the beveled edge and the forces associated with ion-exchange. This increase in warp does not occur when the 2.5D bevel is absent.

Embodiments of the present disclosure are directed to strengthened glass-based articles and methods for reducing warp in strengthened glass-based articles. Embodiments described herein reduce the added warp caused by the above-described interaction between 2.5D or 3D part shape and the ion-exchange process. Processes described herein may provide for an actual warp W_{A} of a strengthened glass-based article that is less than or equal to 85% an expected warp W_{E} of the strengthened glass-based article, less than or equal to 75% an expected warp W_{E} of the strengthened glass-based article, less than or equal to 65% an expected warp W_{E} of the strengthened glass-based article, less than or equal to 55% an expected warp W_{E} of the strengthened glass-based article, less than or equal to 45% an expected warp W_{E} of the strengthened glass-based article, less than or equal to 35% an expected warp W_{E} of the strengthened glass-based article, less than or equal to 25% an expected warp W_{E} of the strengthened glass-based article, less than or equal to 15% an expected warp W_{E} of the strengthened glass-based article, less than or equal to 10% an expected warp W_{E} of the strengthened glass-based article, less than or equal to 5% an expected warp W_{E} of the strengthened glass-based article, or substantially no warp.

As described in more detail below, one or more surfaces of the strengthened glass-based article may be treated before or after one or more ion-exchange processes to reduce an amount of warp. The following techniques, alone or in combination, may be performed to reduce warp in a strengthened glass-based article following one or more ion-exchange processes:
1) Polishing one side of the glass-based article after ion exchange. In the case of multiple ion exchange steps, polishing may occur after any of the polishing steps. As used herein, the term “polishing” should be broadly interpreted to include mechanical or chemical-mechanical grinding, lapping, and polishing processes that may alter the chemistry and/or roughness of the glass near the processed surface while removing material.
2) Etching of one side of the glass-based article after ion exchange.
3) Polishing one side of the glass-based article prior to ion exchange, or differentially polishing one side compared to the other with, for example, different polishing grit sizes.
4) Etching one side of the glass-based article prior to ion exchange, including both laterally uniform etching such as plasma etching or liquid etching, and non-uniform etching such as utilized to create antiglare surfaces; other chemical treatments, for instance highly-alkaline washing, that alter the chemistry or roughness of the glass near the surface and therefore alter the IOX might also be utilized.
5) Pre-warping a glass sheet or a part article, prior to ion exchange, to compensate for the warp observed in ion-exchange. This pre-warping process may include the glass forming process (fusion, rolling, etc.), or a post-forming shaping process such as a bending or molding process or sagging. Sub-methods are: (5a) pre-warping a sheet before cutting to parts, and (5b) pre-warping an individual part.
6) Tilted loading of the glass-based article in an ion exchange bath.

With the exception of process (5a), the above-processes may be applied to an individual glass-based article, such as a phone cover glass. Some of the processes described herein may also be applicable to larger sheets of glass from which individual glass-based articles are separated in cases where the finishing process may allow it. For instance, polishing or etching one side of a larger glass sheet and later cutting and finishing parts from that larger sheet should be anticipated; the efficacy of this approach would partly be determined by whether or not the warp-mitigating surface modification remains after the finishing process prior to ion-exchange. Similarly, a large ion-exchanged glass sheet might then be polished on one side, and parts later cut from it could have the desired shape modifications.

Various embodiments of methods for reducing warp present in strengthened glass-based articles having a 3D or 2.5D shape are described in detail below.

Polishing after Ion-Exchange

In this process, a thin layer of the first compressive stress layer 113A is removed from the convex surface (i.e., the second surface 114 shown in FIG. 5A) of the strengthened glass-based article 100′ after one or more ion-exchange processes. Polishing the second surface 114 results in a second depth of layer that may be less than a first depth of layer associated with the first surface 112.

The polishing of the convex, backside surface of the strengthened glass-based article 100 reduces the effects of warp, and may bring the amount of warp within a desired tolerance. A significant amount of material removal from the convex, backside surface (i.e., a second surface 114) is not required to reduce the warp. For example, less than 1 μm of material may be removed, less than 0.9 μm of material may be removed, less than 0.8 μm of material may be removed, less than 0.7 μm of material may be removed, less than 0.6 μm of material may be removed, less than 0.5 μm of material may be removed, less than 0.4 μm of material may be removed, less than 0.3 μm of material may be removed, less than 0.2 μm of material may be removed. It is noted that removing too much glass material may worsen the warp of the strengthened glass-based article.

Twelve phone-sized glass-based articles were separated from an alkali aluminosilicate glass sheet by a score and break process. The glass-based articles were thinned and polished to about 0.8 mm in thickness following a first finish step F1, and a beveled edge as shown in FIG. 2 was formed in a second finishing step F2 as described above. The individual glass-based articles were then subjected to a first ion-exchange process IOX1 and a second ion-exchange process IOX2. The average CS and DOL on non-bevelled and bevelled sides for the samples was similar with values of 230 MPa and 143 μm after IOX1, respectively, thereby implying a depth of compression (DOC) of about 106 μm). The CS and DOL was measured using the FSM-6000. The warp w of the glass-based articles was measured using a Flatmaster 200.

The results are graphically illustrated in FIG. 8. As can be seen in FIG. 8, where the distribution of warp values for the entire set of twelve glass-based articles is shown after each process step, the warp increases dramatically (greater than 100 μm) after the first ion-exchange process IOX1. The second ion-exchange process IOX2, in which a far-smaller number of ions are exchanged in comparison with the first ion-exchange process IOX1, does not show appreciable additional warp. It is noted that the second ion-exchange process IOX2 resulted in a DOL of about 142 μm and a CS of about 840 MPa. The DOC after the second ion-exchange process IOX2 was slightly deeper than 106 μm by a few microns.

The “backside” (i.e., the convex surface) of each strengthened glass-based article was touch-polished in two separate polishing steps P1 and P2 following the second ion-exchange process IOX2. Touch polishing was performed by a LapMaster 24 sold by LapMaster Wolters of Mt Prospect, Ill. The thinning and polishing of the glass-based articles prior to the two ion-exchange processes were also performed using a LapMaster 24.

The touch polishing process provided a removal rate of about 0.17 μm±0.01 μm removal/minute. In each individual touch polishing step P1 and P2, the strengthened glass-based articles were touch polished for two minutes, resulting in 0.34 μm material removal after the first touch polish P1 and 0.68 μm after the second touch polish P2. Warp was measured after each polishing step. It is noted that glass removal during back-side touch polishing was monitored by both the weight of the strengthened glass parts and their thickness prior to touch polishing and after touch polishing. The thickness of the strengthened glass-based articles was measured using a Tropel MSP150 interferometer sold by Tropel Metrology Instruments of Fairport, N.Y.

As shown by FIG. 8, the subsequent touch polishing steps significantly reduced the amount of warp, on average by more than 50%, after a total of about 0.6 μm of material removal from the backside of the strengthened glass-based articles. Each of the resulting glass-based articles had a resulting warp w that was less than 80 μm. It is noted that, although not shown in FIG. 8, additional touch polishing step removing even more material resulted in increased amount of warp, as the parts begin to be over-corrected by the touch polish process.

Etching after Ion-Exchange

In this process, glass material is removed from the convex, backside (i.e., the second surface 114) using an etching process rather than the touch polishing process described above. The removal of a portion of the second compressive layer results in a warp reduction as described above. For example, less than 1 μm of material may be removed, less than 0.9 μm of material may be removed, less than 0.8 μm of material may be removed, less than 0.7 μm of material may be removed, less than 0.6 μm of material may be removed, less than 0.5 μm of material may be removed, less than 0.4 μm of material may be removed, less than 0.3 μm of material may be removed, less than 0.2 μm of material may be removed.

Any etching solution capable of removing the desired amount of glass material may be utilized. In one non-limiting example, an etching solution comprising HF+HCl/H₂SO₄ is utilized.

Etching the convex, backside surface of the glass-based article after ion-exchange reduces an amount of warp in a manner similar to polishing the glass-based article after ion-exchange as described above. Removal of a portion of the compressive stress layer on the convex, backside surface may reduce the bending moment on the glass-based article, and thus reduce the amount of warp as described above.

To illustrate the effects of material removal by etching, large glass sheets commonly used in electronic displays were evaluated. The glass sheets were 685.8 mm diagonal, 1 mm thick, and were 2D (non-beveled). The glass sheets were strengthened by a first ion-exchange process IOX1. A 1.5M HF+0.9M H₂SO₄ etching solution was applied at a temperature between about 25° C. and about 30° C. to one side or the other to remove glass material. An acid-resistant polymer film was applied to the side that was not etched.

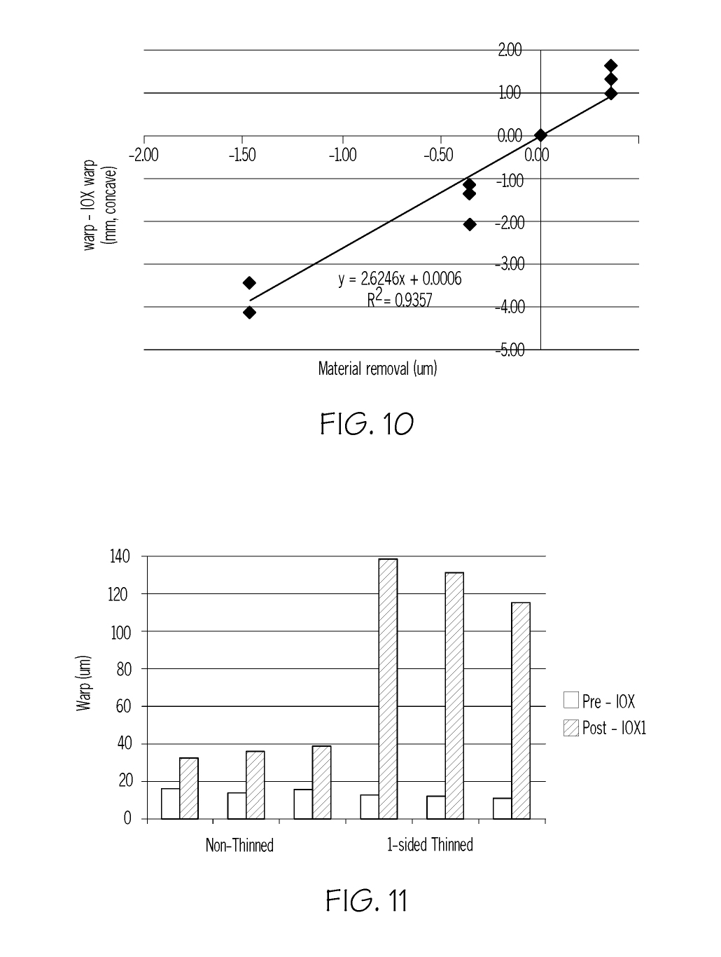

FIG. 9A is a plot of the warp of a particular glass sheet following ion-exchange and prior to any material removal. FIG. 9B is a plot of the warp of the glass sheet depicted in FIG. 9A following 1.5 μm removal of material from the lower side using the etching solution. The glass sheet showed significant warp that was concave toward the etched side. FIG. 10 is a plot that illustrates the amount of warp as a function of material removal by etching from an upper side or a lower side for all of the glass sheets evaluated. A linear relationship may be seen, for example a linear relationship of approximately y=2.6246x+0.0006 with a R² value of 0.9357.

The warp of the glass-based article after etching is due to the unbalanced compressive stress because the DOL on the concave, front side of the glass-based article is thicker than the DOL on the convex, backside of the glass-based article that was etched. Thus, when a glass-based article is 2.5D and warps following the ion-exchange process, the convex, backside surface of the glass-based article may be etched to reduce the amount of warp.

### Polishing Prior to Ion-Exchange

Surface treatments may be performed on a glass-based article prior to ion-exchange that changes the ion-diffusivity within the desired surface during the ion-exchange process. The surface treatment may be mechanical polishing or etching, for example.

In one process, the backside (i.e., the second surface 114 shown in FIG. 6A) of the strengthened glass-based article is polished prior to subsequent ion-exchange processes. Thus, the glass-based articles may be polished prior to ion-exchange to pre-compensate for warp that occurs as a result of the ion-exchange.

This concept was tested utilizing 2D (i.e., flat with no asymmetric edges) phone-size alkali aluminosilicate glass articles. Three glass articles were thinned from approximately 1.0 mm to 0.9 mm thickness by one-sided lapping and polishing using a LapMaster 24, leaving the second side with an as-made fusion surface. For comparison, three other glass articles were made from the same glass but not thinned, so both sides had the as-made fusion surface. Both sets of parts were subjected to an ion-exchange process. For the non-thinned samples, the CS/DOL was 250.4 MPa/143.1 μm on one side and 251.4 MPa/143.3 μm on the other side. For the polished sample, the CS/DOL was 235.6 MPa/142.6 μm on the polished surface and 246.3 MPa/142.2 μm on the as-made fusion surface.

FIG. 11 graphically depicts the resulting warp as measured by a FlatMaster 200. As can be seen from FIG. 11, the non-thinned parts showed relatively-small warp changes (approximately 15 μm), while the thinned parts showed extremely large changes in warp (>100 μm). Thus, pre-ion exchange polishing may be utilized to pre-compensate for predicted warp following ion-exchange. In other words, the backside (i.e., the second surface 114 shown in FIG. 6A) of a 2.5D glass article may be polished in advance of the ion-exchange process in anticipation of the amount of warp that will result from the ion-exchange process. Thus, the pre-polishing of the backside surface will counteract the warp of the 2.5D glass article due to the ion-exchange process.

It is noted that warp may depend on the surface finishing process. The one-sided pre-ion-exchange polishing mechanism can be generalized from the demonstrated non-thinned/thinned surface difference other types of process differences in surface treatment. Since asymmetry of ion-exchange (strain) drives warp, creating a deliberate asymmetry of surface processing before ion-exchange can introduce a warp driver of the opposite sign and reduce the network of ion exchange. This generalization may allow the amount of warp to be “tuned” more effectively.

Both surfaces of the glass-based article may be polished to result in asymmetric ion diffusivity. For example, the first surface 112 of the glass-based article 100 may be polished resulting in a first ion diffusivity during ion-exchange, and the second surface 114 of the glass-based article 100 may be polished resulting in a second ion diffusivity during ion exchange. In this manner, the ion diffusivity difference between the two surfaces may be tuned to result in lower warp. As an example and not a limitation, the difference in polishing may be the amount of material removed and/or the grit size used to polish the two surfaces.

### Etching Prior to Ion-Exchange

Etching a surface of the glass-based article prior to ion-exchange has also been shown to affect the amount of warp following ion-exchange. However, etching a surface prior to ion-exchange has an opposite effect as compared to polishing a surface prior to ion-exchange. When polishing prior to ion-exchange, the warp causes the polished side to become concave. However, when etching a surface prior to ion-exchange, the warp causes the etched side to become convex.

This concept was tested utilizing large alkali aluminosilicate glass sheets commonly used in electronic displays. The glass sheets were 685.8 mm diagonal, 1 mm thick, and were 2D (non-beveled). In this experiment, the glass sheets were first acid etched using a 1.5M HF+0.9M H₂SO₄ etching solution at a temperature between about 25° C. and about 30° C., removing small amounts of glass from one side or the other. Two different etching process conditions were tested, one in which the etching solution removed approximately 0.4 μm from the glass surface and the other in which it removed approximately 1.5 μm from the glass surface. The process conditions for these removal amounts were determined in pre-tests and confirmed in thickness measurements of the tested parts. An acid-resistant polymer mask was used to prevent etching on one side of a sample, where desired, and different samples were etched differently—some etched on their “A” side only, some on their “B” side only, and some on both sides. The mask material was removed after etching and prior to ion-exchange. The amount of warp was measured before and after the etch process utilizing the “Bed of Nails” (BON) “gravity free” measurement system described above. This pre-IOX etching process was shown to leave the warp unchanged from its initial pre-etch value.

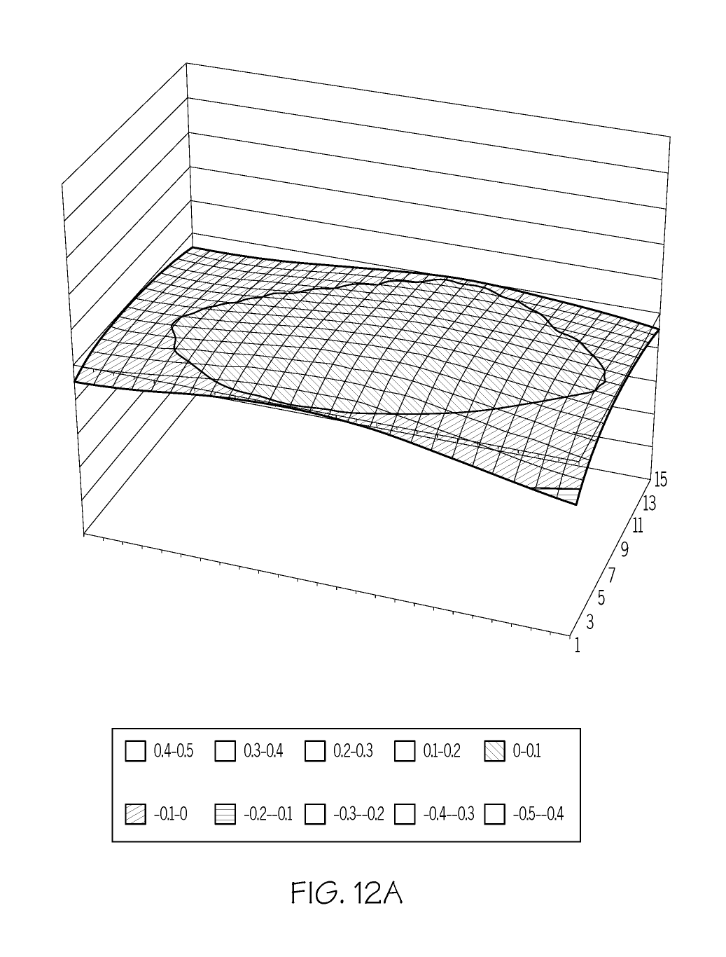

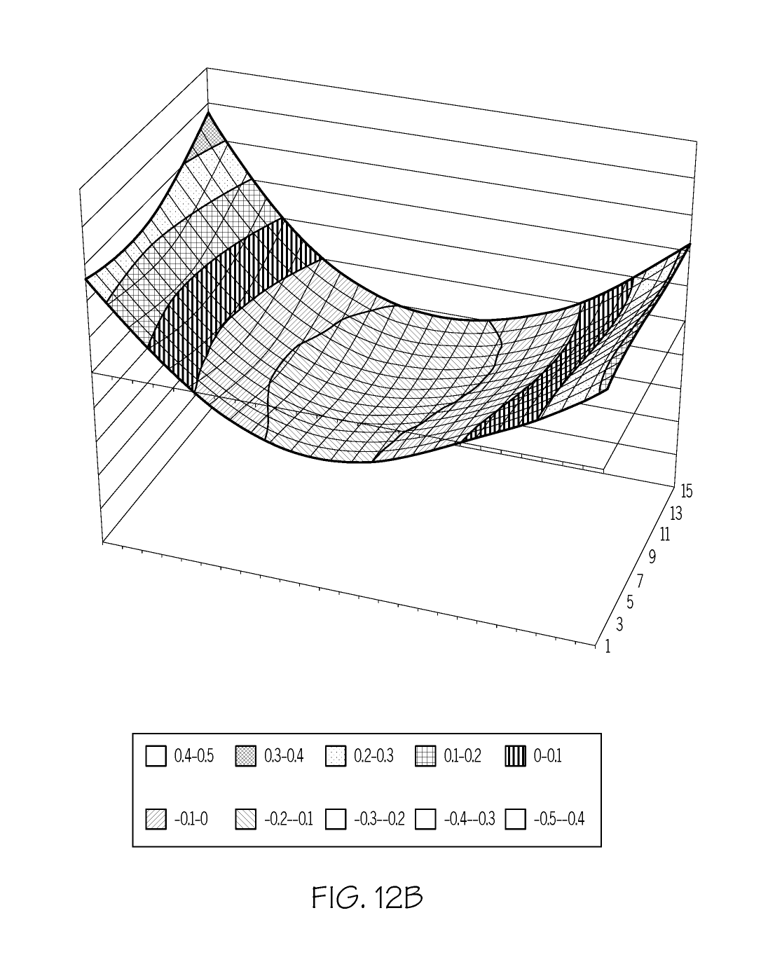

After measuring the warp of the glass sheets, the glass sheets were then ion-exchange in a KNO₃ salt bath at 370° C. for 105-110 minutes to achieve a CS of about 820 MPa and a DOL of about 40 μm. Warp was again measured after ion-exchange. FIG. 12A is a plot of the warp of a particular glass sheet prior to ion-exchange and after a surface of the glass sheet was etched to remove about 0.4 μm of glass material. FIG. 12B shows the glass sheet of FIG. 12A after ion-exchange. The glass sheet showed significant warp that was concave toward the non-etched side, and convex toward the etched side.

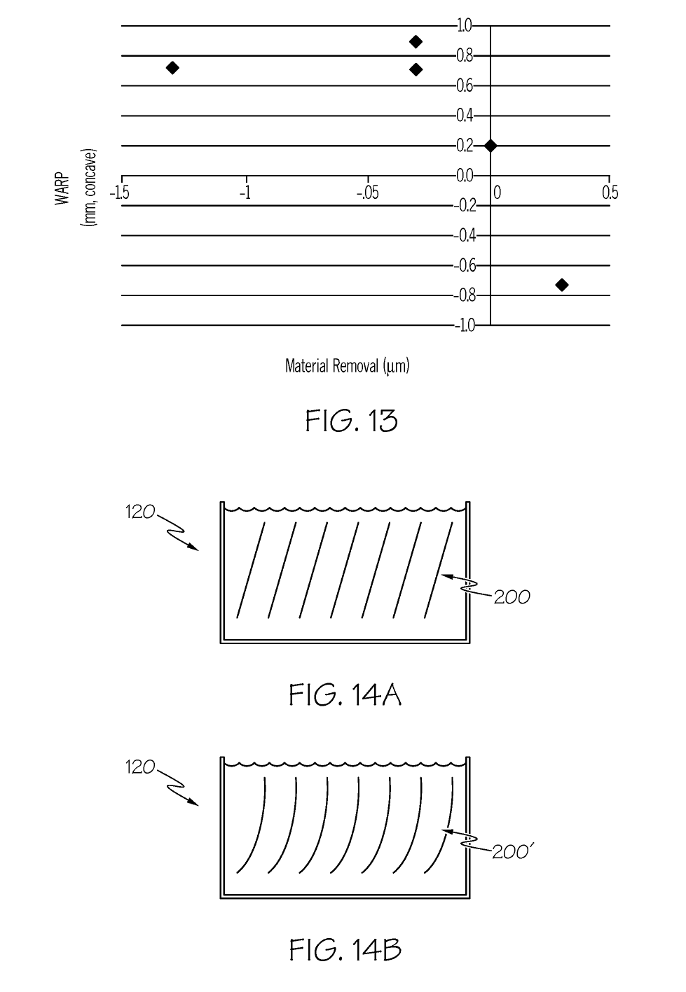

FIG. 13 is a plot showing the data for all the glass sheets tested in this experiment, where the amount of warp change resulting from etching is shown as a function of the difference in etch removal between the sides. It is noted that the effect appears to saturate, and etching more than about 0.4 μm does not appear to alter the amount of warp. The non-zero value of warp at Material Removal=0 is believed to be the result of the tilt loading the glass sheets during ion-exchange, which is described below, and forms an offset of about +0.2 mm warp for all the data in the experiment.

It is noted that both surfaces of the glass-based article may be etched to result in variable ion diffusivity. For example, the first surface 112 of the glass-based article 100 may be etched resulting in a first ion diffusivity during ion-exchange, and the second surface 114 of the glass-based article 100 may be etched resulting in a second ion diffusivity during ion exchange. In this manner, the ion diffusivity difference between the two surfaces may be tuned to result in lower warp. As an example and not a limitation, the difference in polishing may be the amount of material removed and/or the grit size used to polish the two surfaces.

### Pre-Warping Glass-Based Article Prior to Ion-Exchange

In some embodiments, the amount of warp in a glass-based article resulting from an ion-exchange process may be compensated by forming the glass-based article with a certain amount of warp in a direction or orientation opposite from the post-ion-exchange warp. The amount of warp seen in glass-based articles is observed to be a linear addition of initial shape to ion exchanged-induced change in shape. If a there is a high level of warp or deformation at a location of the glass-based article before ion-exchange, the amount of warp due to ion-exchange will be added to the high level of warp or deformation at that location. If the shape change induced by ion exchange is known by theory or measurement, this shape can be subtracted from the initial shape during formation of the part. The pre-shaped part will then be relatively flat after adding its initial shape and its ion exchange-induced change in shape.

Finite-element modeling has been shown to give semi-quantitative predictions of actual part warp. Models of parts with an initial warp of various amplitudes have shown that the change in warp because of the 2.5D shape plus ion-exchange warp effect is, to good approximation, independent of the initial pre-ion-exchange part warp. Thus, if the glass-based article can be pre-shaped by an amount approximately equal and opposite to the change in shape during ion-exchange, the resultant shape may be close to flat.

As a non-limiting example, a modeled 2.5D glass-based article with a simple cylindrical shape and similar amplitude (55 μm across the part) but opposite sign to the predominant ion-exchange warp along the long axis of the part, showed substantial reduction of the final part warp from 61 μm to 24 μm in simulation, as shown in Table 1 below.

TABLE 1

| Pre-IOX Warp W_{P} | 1^{st} IOX Warp | 2^{nd} IOX Warp |
|---|---|---|
| 0 (flat) | 50 μm | 61 μm |
| −55 μm | 22 μm | 24 μm |

Thus, glass-based articles may be fabricated with a pre-existing warp in a negative direction as the warp caused by the ion-exchange process to cancel out the overall resulting warp.

In embodiments, the expected warp W_{E} metric may be calculated for a particular glass-based article having a particular stress profile and a particular asymmetric edge geometry. Prior to the ion-exchange process, the glass-based article may be pre-warped by a pre-warp W_{P} to have an initial warp that is about the same amount as the expected warp W_{E} metric but opposite in sign. Thus, the expected warp W_{E} metric may be referenced to make an informed decision as to how much to pre-warp the glass-based article. The glass-based article may be pre-warped prior to cutting a glass-based sheet into glass-based articles, or after cutting the glass-based sheet into glass-based articles (i.e., pre-warping individual parts).

Any process may be used to pre-warp the glass-based article. The pre-warp may be introduced during the draw of the glass-based article, or subsequent to the draw process, such as by a rolling process, for example.

### Tilt Loading Glass-Based Article in Ion-Exchange Bath

Referring now to FIG. 14A, positioning a glass-based article 200 within the ion-exchange bath 120 at an angle causes warp in a direction toward the bottom of the ion-exchange bath 120. This is particularly true with respect to larger glass sheets, such as those used in television displays or computer monitors. FIG. 14A schematically depicts an experiment in which non-warped glass-based articles 200 are tilted in an ion-exchange bath at an angle of approximately 5°. For this experiment, alumino-silicate glass sheets were 685.8 mm diagonal, 1 mm thick, and were 2D (non-beveled). FIG. 14B schematically depicts the glass sheets 200′ at the end of ion-exchange process, with the parts all warped towards the “front” of the ion-exchange bath 120. In the experiment, the left is the “front” of the ion-exchange bath 120 and the right is the “back” of the ion-exchange bath 120, so all parts were tilted backwards, part tops towards the back of the ion-exchange bath 120.

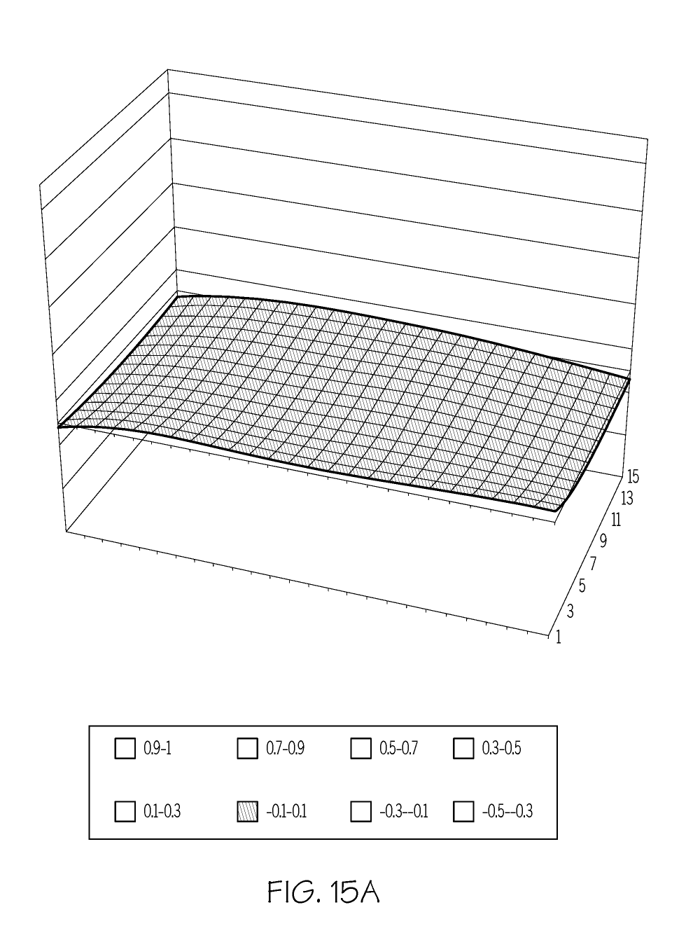

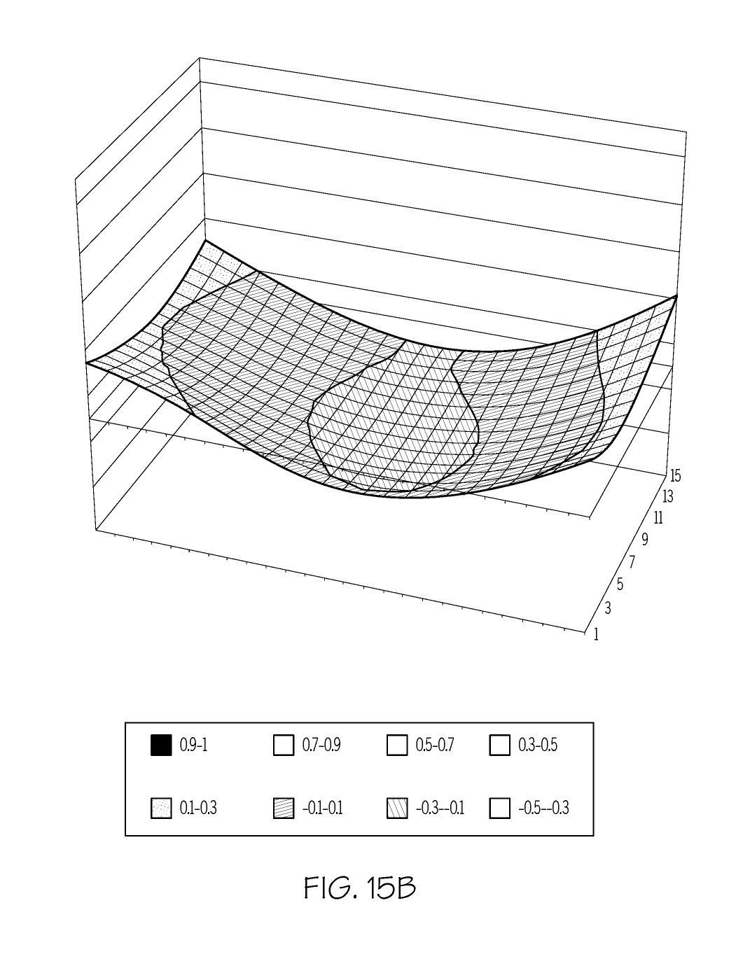

FIG. 15A graphically illustrates a plot showing the warp of a 685.8 mm diagonal glass sheet prior to ion-exchange. FIG. 15B graphically illustrates a plot showing the warp of the 685.8 mm diagonal glass sheet of FIG. 15A after ion-exchange. The glass sheets were ion-exchanged in a KNO₃ salt bath at 370° C. for 105-110 minutes to achieve a CS of about 820 MPa and a DOL of about 41 μm. The bottom face of the glass sheet, as illustrated in FIGS. 15A and 15B, was tilted towards the back of the ion-exchange bath.

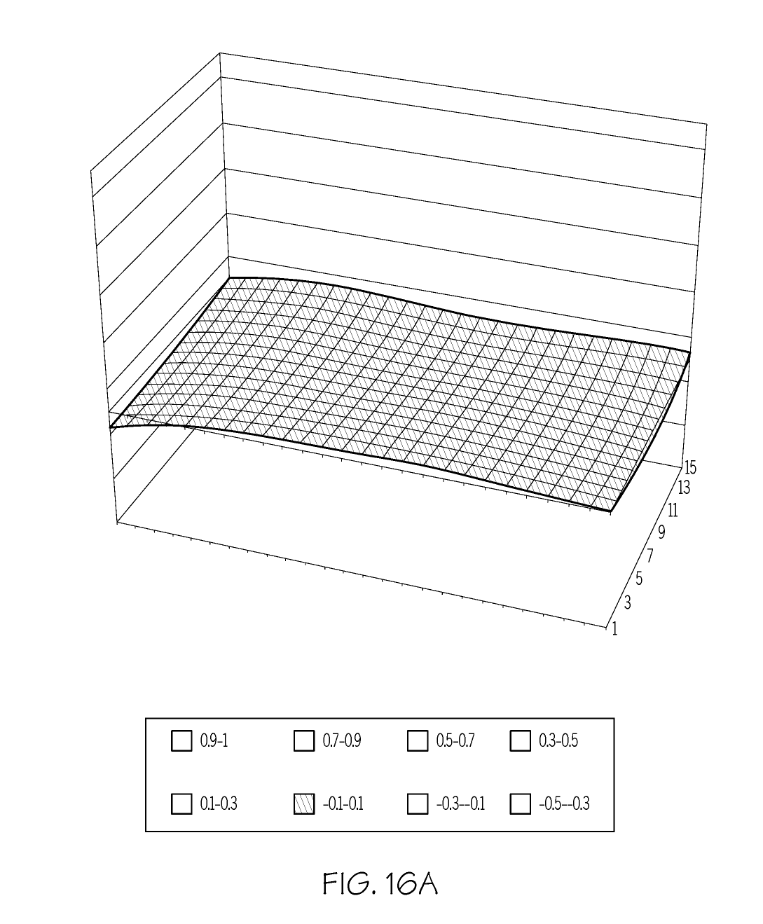

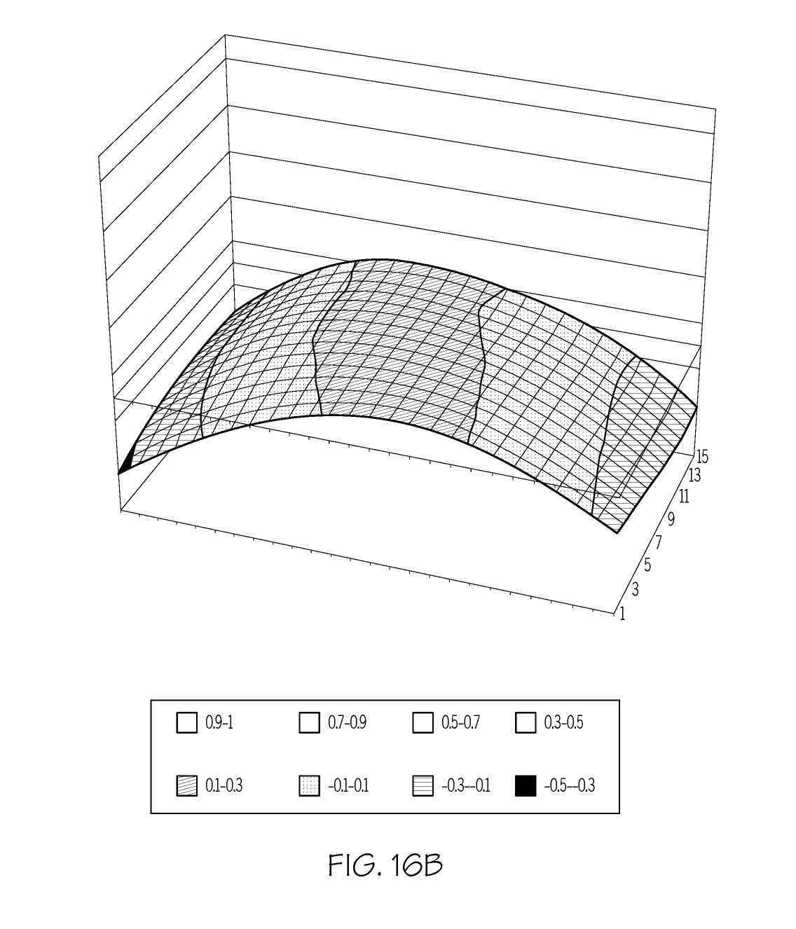

For comparison, FIG. 16A is a plot showing the warp of a 685.8 mm diagonal glass sheet prior to ion-exchange, and FIG. 16B shows the warp of the glass sheet after ion-change, where the top of the glass sheet, as illustrated in FIGS. 16A and 16B, was tilted towards the back of the ion-exchange bath.

A total of twelve glass sheets were tested in this experiment. Each of the glass sheets were consistently convex towards the back of the ion-exchange bath. This approach has been shown to produce significant warp in larger parts, such as the 685.8 mm diagonal glass sheet utilized in the experiment described above. Glass-based articles may be preferentially positioned within the ion-exchange bath to counteract warp induced by the ion-exchange process.

Thus, embodiments described herein provide chemically strengthened glass-based articles, particularly strengthened glass-based articles having a 2.5D or 3D shape, or relatively large strengthened glass-based articles, having reduced warped due to the ion-exchange process.

It should now be understood that embodiments described herein are directed to methods for mitigating warp in 2.5D and 3D glass-based articles. The methods described herein may be used in combination to achieve the desired warp mitigation.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1-34. (canceled)

35. A strengthened glass-based article comprising:
a first surface having a first compressive stress layer extending from the first surface into a bulk of the strengthened glass-based article;
a second surface having a second compressive stress layer extending from the second surface opposite the first surface and into a bulk of the strengthened glass-based article, wherein each of the first compressive stress layer and the second compressive stress layer has a depth of compression of the smaller of greater than or equal to 40 μm or greater than or equal to 10% of a thickness of the strengthened glass-based article; and
an edge between the first surface and the second surface, wherein:
the edge provides a non-orthogonal transition between the first surface and the second surface such that the edge is asymmetric with respect to a plane that is located at an average depth of the strengthened glass-based article and is parallel to the first surface and the second surface;
the strengthened glass-based article has an expected warp W_{E} based at least in part on a shape of the asymmetric edge of the strengthened glass-based article;
an actual warp W_{A} of the strengthened glass-based article is less than 85% of the expected warp W_{E} of the strengthened glass-based article; and
the actual warp W_{A} of the strengthened glass-based article is measured with a concave surface facing up.

36. The strengthened glass-based article of claim 35, wherein the strengthened glass-based article has a rectangular shape comprising a width and a length that is greater than the width.

37. The strengthened glass-based article of claim 35, wherein the glass is formed using a nominally symmetric forming process in a thickness direction of the strengthened glass-based article.

38. The strengthened glass-based article of claim 35, wherein an ion exchange process produces a ratio of the expected warp W_{E} to a longest dimension of the glass-based article that is greater than 0.0006.

39. A method of fabricating a strengthened glass-based article, the method comprising:
positioning a glass-based article into an ion-exchange bath for a duration of time, wherein:
the glass-based article comprises a first surface, a second surface opposite the first surface, and an edge between the first surface and the second surface;
the edge provides a non-orthogonal transition between the first surface and the second surface such that the edge is asymmetric with respect to a plane that is located at an average depth of the strengthened glass-based article and is parallel to the first surface and the second surface; and
the ion-exchange bath forms the strengthened glass-based article, the strengthened glass-based article comprising:
a first compressive stress layer extending from the first surface into a bulk of the strengthened glass-based article and having a first depth of compression; and
a second compressive stress layer extending from the second surface into the bulk of the strengthened glass-based article and having a second depth of compression;
after positioning the glass-based article to the ion-exchange bath, removing a portion of at least the second compressive stress layer such that a warp of the strengthened glass-based article after removing the portion of at least the second compressive stress layer is less than a warp of the strengthened glass-based article before removing the portion of at least the second compressive stress layer.

40. The method of claim 39, wherein the warp after removing the portion of at least the second compressive stress layer is less than or equal to 85% of the warp before removing the portion of at least the second compressive stress layer.

41. The method of claim 39, wherein removing the portion of at least the second compressive stress layer comprises mechanically polishing the first surface of the strengthened glass-based article.

42. The method of claim 39, wherein removing the portion of at least the second compressive stress layer comprises applying an etching solution to the first surface.

43. The method of claim 39, wherein a thickness of the removed portion of the second compressive stress layer is greater than or equal to 0.25 μM.

44. A method of fabricating a strengthened glass-based article, the method comprising:
applying a surface treatment to at least a portion of a first surface of a glass-based article, the glass-based article comprising the first surface, a second surface opposite the first surface, and an edge between the first surface and the second surface, wherein the edge provides a non-orthogonal transition between the first surface and the second surface, and the edge is asymmetric with respect to a plane that is located at an average depth of the strengthened glass-based article and is parallel to the first surface and the second surface;
positioning the glass-based article into an ion-exchange bath for a duration of time, wherein:
the ion-exchange bath strengthens the glass-based article to form the strengthened glass-based article;
the strengthened glass-based article comprises a first compressive stress layer extending from the first surface into a bulk of the strengthened glass-based article thereby defining a first depth of compression, and a second compressive stress layer extending from the second surface opposite the first surface and into a bulk of the strengthened glass-based article thereby defining a second depth of layer; and
the surface treatment results in an ion diffusivity in the first compressive stress layer that is different from an ion diffusivity in the second compressive stress layer.

45. The method of claim 44, wherein:
the strengthened glass-based article has an expected warp W_{F} based at least in part on a shape of the asymmetric edge of the strengthened glass-based article; and
an actual warp W_{A} of the strengthened glass-based article is less than 85% of the expected warp W_{E} of the strengthened glass-based article; and
the actual warp W_{A} of the strengthened glass-based article is measured with a concave surface facing up.

46. The method of claim 44, wherein each of the first compressive stress layer and the second compressive stress layer has a depth of compression of the smaller of greater than or equal to 40 μm or greater than or equal to 10% of a thickness of the strengthened glass-based article.

47. The method of claim 44, further comprising applying a second surface treatment to the second surface, wherein the second surface treatment to the second surface is different from the surface treatment to the first surface.

48. The method of claim 44, wherein applying the surface treatment comprises removing a portion of the first compressive stress layer.

49. The method of claim 44, wherein a thickness of the removed portion of the first compressive stress layer is within a range of 0.1 μm and 5 μm.

50. The method of claim 44, wherein the surface treatment comprises polishing at least one of the first surface and the second surface.

51. The method of claim 44, wherein the surface treatment comprises etching at least one of the first surface and the second surface.

52. A method of fabricating a strengthened glass-based article, the method comprising:
positioning a glass-based article into an ion-exchange bath for a duration of time, wherein:
the glass-based article comprises a first surface, a second surface opposite the first surface, and an edge between the first surface and the second surface, wherein the edge provides a non-orthogonal transition between the first surface and the second surface and the edge is asymmetric with respect to a plane that is through an average depth of the strengthened glass-based article and is parallel to the first surface and the second surface;
the glass-based article is tilted within the ion-exchange bath such that one of the first surface and the second surface faces away from a bottom of the ion-exchange bath; and
removing the strengthened glass-based article from the ion-exchange bath after the duration of time, wherein:
the strengthened glass-based article comprises a first compressive stress layer extending from the first surface into a bulk of the strengthened glass-based article to a first depth of layer, and a second compressive stress layer extending from the second surface opposite the first surface and into a bulk of the strengthened glass-based article to a second depth of layer; and
the strengthened glass-based article has an expected warp W_{E} based at least in part on a shape of the asymmetric edge of the strengthened glass-based article;
an actual warp W_{A} of the strengthened glass-based article is less than 85% of the expected warp W_{E} of the strengthened glass-based article; and
the actual warp W_{A} of the strengthened glass-based article is measured with a concave surface facing up.

53. The method of claim 52, wherein each of the first compressive stress layer and the second compressive stress layer has a depth of compression of the smaller of greater than or equal to 40 μm or greater than or equal to 10% of a thickness of the strengthened glass-based article.

54. A method of fabricating a strengthened glass-based article, the method comprising:
pre-warping a glass-based article such that the glass-based article has a pre-warp W_{P} in a first direction, the glass-based article comprising a first surface, a second surface, and an edge between the first surface and the second surface, wherein the edge provides a non-orthogonal transition between the first surface and the second surface such that the edge is asymmetric with respect to a plane that is located at an average depth of the glass-based article and is parallel to the first surface and the second surface;
positioning the glass-based article into an ion-exchange bath for a duration of time, wherein:
the ion-exchange bath forms the strengthened glass-based article such that:
a first compressive stress layer extends from the first surface into a bulk of the strengthened glass-based article to a first depth of layer; and
a second compressive stress layer extends from the second surface into the bulk of the strengthened glass-based article to a second depth of layer;
the strengthened glass-based article has an expected warp W_{E} based at least in part on a shape of the asymmetric edge of the strengthened glass-based article;
the strengthened glass-based article warps in a second direction opposite the first direction of the pre-warp W_{P} such that an actual warp W_{A} of the strengthened glass-based article is less than 85% of the expected warp W_{E} of the strengthened glass-based article; and
the actual warp W_{A} of the strengthened glass-based article is measured with a concave surface facing up.
